(19) United States
(12) Patent Application Publication
(10) Pub. No.: US 2014/0025592 A1
(43) Pub. Date: Jan. 23, 2014

(54) Seller Driven Real Estate Commerce

(71) Applicants: Larry Dwayne Wright, Edgewood, WA (US); Deborah Ann Wright, Edgewood, WA (US)

(72) Inventors: Larry Dwayne Wright, Edgewood, WA (US); Deborah Ann Wright, Edgewood, WA (US)

(21) Appl. No.: 13/943,794

(22) Filed: Jul. 17, 2013

Related U.S. Application Data
(60) Provisional application No. 61/672,479, filed on Jul. 17, 2012.

(51) Int. Cl. G06Q 50/16; G06Q 30/06

(52) U.S. Cl. CPC G06Q 50/167; G06Q 30/0613
USPC 705/316

(57) ABSTRACT

The invention is a system and method for generating seller-driven real estate commerce. The invention enables sellers of real property to communicate information about their available real estate directly to prospective buyers, and simultaneously extend offers of compensation directly to licensed real estate professionals. The real estate information is validated for accuracy and reliability, then confidential information is shared internally within a database assisted network of real estate professionals, and general information is distributed for public access. Potential buyers have the option of negotiating directly with sellers to create a binding purchase and sale agreement, or buyers may employ a licensed real estate professional to facilitate the purchase. When a licensed real estate professional is employed, that professional is paid according to the seller's original offer of compensation.

### COPYRIGHT NOTICE

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

The present invention is in the field of real estate commerce. More particularly, the present invention is in the field of Information about available real estate and compensation offers for real estate licensees.

2. Description of the Related Art

Not Applicable

3. Background

From their home based business in Washington, the inventors have assisted real estate owners in the successful marketing of 159 properties and saved them in excess of $2 million in brokerage fees. These transactions resulted in over $1 million paid to real estate firms and nearly $1 million of tax revenue paid to State and local governments. Additionally, according to the National Association of Realtors (NAR), these sales generated 78 jobs. These consumers, professionals, governments and employees have benefitted from the cost saving efficiencies enabled by the inventors' innovative departure from traditional real estate practices, achieved within the confines of the traditional real estate brokerage industry. The invention specified below liberates owners of real estate from the restrictions of traditional practices in broker-driven real estate commerce and enables exponentially greater results.

Licensed and regulated by states, real estate professionals typically fall into one of two categories: brokers and agents. Agents work directly with buyers and sellers under the supervision and management of brokers. For the purpose of this invention all licensed real estate professionals are referred to as “Brokers”,

Currently, real estate commerce is dominated by a broker-driven system that accounts for approximately 90% of all residential home sales in the United States. It is broker-driven in so far as the effective systems and methods are available exclusively to real estate brokers, allowing them to control the pricing and terms for their services.

Traditionally, it is the broker's responsibility to attract buyers and then to facilitate the sale. The costs of marketing and the risk that efforts will be unsuccessful fall on the broker. Sellers who market their property themselves as a “for sale by owner” (FSBO) must assume these same costs and risks.

A homeowner who chooses to hire a real estate broker rather than selling a home on his/her own enters into an exclusive contractual relationship commonly referred to as a “listing agreement”. In this contract the listing broker agrees to market and sell the home and the homeowner agrees to pay a commission if the home is sold while the agreement is in effect. The listing agreement also specifies how the home is to be marketed to “cooperating brokers” by way of the Multiple Listing Service (MLS), and how to compensate a cooperating broker who works with the buyer. The listing broker's offer of compensation to cooperating brokers is a unilateral contract, obligating the listing broker to pay only when the cooperating broker produces a buyer. The listing information, along with the listing broker's blanket unilateral offer of compensation, is entered into the MLS database for dissemination to numerous potential cooperating brokers, who can inform potential buyers of the available home for sale.

Real estate Multiple Listing Services are local, private, business to business cooperative ventures with access restricted exclusively to real estate brokers and affiliated professionals (appraisers, title officers, etc.). Brokers use their local MLS to share their stock of available properties with other brokers in attempt to attract ready, willing and able buyers, and to complete sales. MLSs are convenient sources of information, allowing real estate brokers to provide maximum exposure for their sellers and simplify property searches for buyers. The core functions of an MLS are to share information about available properties and facilitate blanket unilateral offers of compensation between participants.

There are three types of listing agreements. Most preferred and used by brokers is the “exclusive right to sell” contract which assures the listing broker is paid if the property is sold during the listing term. In an “exclusive agency” agreement the listing broker is paid when any broker finds a buyer, but not when the seller finds the buyer. An “open listing” agreement is a nonexclusive unilateral contract obligating the seller to pay when the broker finds a buyer. Only exclusive agreements contain provisions to compensate cooperating brokers and for this reason an exclusive agreement is required to enter a listed property into the MLS.

The legal broker-client agency relationship creates a high level of responsibility for the broker and differs from state to state. Typically, upon signing an exclusive listing agreement, the broker becomes a fiduciary, required to act in the seller's best interest. Listing brokers usually represent and owe fiduciary duties to sellers. Until the 1990s cooperating brokers were considered subagents of listing brokers, also owing fiduciary duties to sellers. Currently, cooperating brokers most commonly represent and owe fiduciary duties to buyers. However, subject to state laws, a broker may also owe fiduciary duties to both buyer and seller simultaneously, or neither the buyer nor the seller when hired to fecililate a specific transaction. In the inventors' experience, the most common error made on real estate purchase and sale agreements is misrepresentation of the seller's agency relationship.

When a buyer makes an offer to purchase a property, the listing broker may assist the seller with negotiations and counteroffers to achieve a mutually acceptable agreement between the buyer and seller. Once a seller accepts an offer, the property sale is contracted and contingencies of the agreement must be satisfied. These typically include inspections, appraisals, financing, clear title, insurance and repairs. A listing broker and cooperating broker will normally work together to facilitate the transaction. When, all contingencies are met, the parties proceed to closing where the purchase money is exchanged for the property title, and the listing broker and cooperating broker are compensated in accordance with the listing agreement. Over a long period of time, the commission paid to brokers at closing has persisted at roughly 5 to 7 percent of the property's selling price.

Real estate brokerage fees have increased at a rate that substantially outpaces inflation and tend to be uniform, regardless of local market conditions or the amount of resources required to sell varying properties. Consumers, economists and government agencies have all questioned to what degree price competition actually exists. The United States Government Accountability Office (GAO), Department of Justice (DOJ), and Federal Trade Commission (FTC) have all identified the cooperative use of Multiple Listing Services as a contributing cause of the real estate industry's lack of price variation.

MLSs are vitally important to broker-driven real estate purchases and sales within regional real, estate markets, so much so that participation is required for any broker to effectively compete. Upon entering property information into the MLS database, a listing broker's prearranged offer of compensation is extended to many potential cooperating brokers whose potential buyers learn about the property in a variety of ways. Online searches of aggregated MLS listing data provide access to virtually every available property, except FSBOs. Over 80% of home buyers cite internet MLS searches as the most important tool used in finding their new home.

Over eight, hundred real estate MLSs operate in the United Slates today in support of broker-driven real estate commerce. By design, their authorized use for dissemination of real estate information is only available to brokers, to the exclusion of the general public.

Typical real estate brokers spend more time and resources competing amongst themselves for clients than they do productively selling real estate. Even so, real estate brokerage firms continuously recruit new brokers and spend tremendous sums for advertising that results in little benefit to consumers. The FTC and DOJ has documented that in the year 1990, such excesses resulted in “social waste” of up to $8.2 billion. In the conclusion of their joint report dated April 2007, the FTC and DOJ documented that competition in the real estate brokerage industry has been hindered by brokers acting through MLSs, NAR, state legislatures and commissions. The DOJ and FTC recommended that states and agencies promote consumer awareness and understanding of options within the real estate marketplace, stating that competition in the real estate brokerage industry would be enhanced, A new seller-driven system of real estate commerce is more likely to accomplish this because the federal recommendation conflicts with the best self-interest of real estate professionals in control of the existing broker-driven system which steers sellers into exclusive agreements.

In recent years, 35%-40% of the typical, home seller's appreciated value gains were consumed by real estate brokerage fees. The most common reason for a seller to market a property themselves as a FSBO is to avoid paying expensive brokerage fees. These FSBO consumers roust resort to alternative methods like placing ads in local media, posting signs, and hosting their own open houses. Even though FSBOs routinely offer compensation to a broker representing a buyer, their information is not accepted into the MLS database so they cannot effectively communicate blanket unilateral offers of compensation with real estate brokers.

There are numerous websites on the Internet devoted to marketing FSBO properties. Examples include: forsalebyowner.com, craigslist.org. fsbo.com, homesbyowner.com, etc. However, such websites are inaccurate, unreliable and easily exploited. Anybody can advertise an actual/fictitious property, offered by an actual/fictitious entity, with or without an actual/fraudulent offer of compensation. Additionally, there is no alternative which provides a consistent mechanism of confidentially communicating the sellers unilateral offer of compensation to real estate brokers, creating a potential conflict between buyers and the broker assisting them. A seller-driven system of real estate commerce which authenticates the integrity of information pertaining to properties for sale and offers of compensation for brokers is needed to attract the attention of potential buyers' brokers.

Unlike airline travel, stock brokerage, hotel reservations and entertainment ticketing. real estate consumers as a whole have not financially benefited from the cost saving efficiencies enabled by the Internet. A third party is needed to facilitate a seller-driven system of real estate commerce, serving as a trusted aggregator and disseminator of information into and from a central database. The third party can establish standard procedures to ensure the integrity of real estate information about available properties and offers of compensation for brokers, thereby increasing buyer, seller and broker confidence in the system. Additionally, the third party can administer an Internet website where sellers enter information about, properties for sale or lease, along with their offers of compensation for brokers. Maintaining all information in a centralized database simplifies a brokers search for properties relevant to their buyers' needs, and simplifies distribution of information to other third parties for republication.

The inventors are unaware of any seller-driven real estate commerce system which contains the above features and addresses the above shortcomings. It is one object of the invention to provide a system and methods which create seller-driven real estate commerce that enables owners of real estate to communicate information about their available real estate directly to prospective buyers, and simultaneously extend offers of compensation directly to real estate brokers.

Another object of the invention is to validate the seller's information for accuracy and reliability.

Yet a further object of the invention is to provide a method in which the identity of the seller is verified along with the seller's capacity to convey ownership of the subject property and the integrity of the seller's blanket unilateral, offer of compensation to brokers.

Yet another object of the invention is to restrict access to the seller's confidential information.

A further object of the invention is to provide for a trusted third-party aggregator to maintain sellers' real estate information.

Another object of the invention is to show how the system, either partially or entirely, can be accomplished using non-electronic documentation such as printed forms.

Another object of the invention is to provide system and methods to bind a seller to honor his blanket unilateral offer of compensation to brokers upon satisfaction of conditions identified by the seller.

These and other objects will be apparent from the following description of the invention, the attached drawings and appended claims.

At the heart of the invention is the discovery of how the sellers of real property can communicate information about their available real, estate directly to prospective buyers, and simultaneously extend offers of compensation directly to licensed real estate brokers,

In a preferred embodiment, this invention provides a system and method for sellers of real property to communicate an offer of compensation globally to licensed real estate brokers who are assisting prospective buyers, and tor sellers to clearly specify the fiduciary duties of the broker to be compensated. Additionally, the invention facilitates identification of the subject property's common characteristics such as lot size, structure size, bedrooms, and bathrooms. This common information can be disseminated to various third parties for republication and unrestricted access by the general public, thereby attracting potential buyers to the property. The invention can also catalog transaction specific data such as price, geographic area, broker compensation, agency relationships, type of financing and seller concessions. The invention creates an effective and efficient system of seller-driven real estate commerce that improves the ability of sellers to attract capable buyers, improves the ability of buyers to discover properties suitable to their needs, improves the disclosure of agency relationships for all parties, improves offers of compensation extended to real estate brokers, and aggregates previously unrecorded information pertaining to a significant portion of all real estate transactions not facilitated by real estate brokers.

Communicating sellers' blanket offers of compensation to brokers is primarily accomplished using a central database accessed by secure website on the Internet. A broker, assisting a buyer in his/her search for a property to purchase, accesses the central database and identifies available properties that may satisfy the buyer's needs. When the buyer selects a property to purchase, the broker submits an offer in the form of a purchase and sale agreement (PSA) which specifies the terms and conditions the buyer requires. Typically, negotiations ensue until the terms and conditions documented on the PSA are mutually agreed to by both the buyer and seller. The seller's original offer of compensation to the broker is subject to change during negotiations. Upon the buyer's performance of completing the purchase of the property as agreed, the broker is paid in accordance with the sellers offer of compensation. A buyer may also choose to negotiate directly with the seller and purchase the property without the assistance of a real estate broker, In which case the seller pays no compensation.

The central database consists of common, commercially available, component computers and server software which may include database servers), web application sewers, Internet information servers, media servers etc. To ensure integrity of the system, authorized staff may review documents that validate seller, property and broker information contained within the database. Brokers must provide credentials that validate his/her status as an active real estate licensee prior to accessing information. Likewise, sellers are required to provide credentials that validate his/her legal capacity to convey title to a subject property prior to releasing the property information for public access, and making the seller offer of compensation available to brokers.

### DESCRIPTION OF THE DRAWINGS

FIG. 1 is an illustration of a first embodiment of the present invention.

FIG. 2 illustrates how real estate information is entered and an offer of compensation is generated.

FIG. 3 illustrates how real estate information and an offer of compensation is validated.

FIG. 4 illustrates how a broker is compensated in accordance with the seller's blanket unilateral offer of compensation

### DESCRIPTION OF THE PREFERRED EMBODIMENT(S)

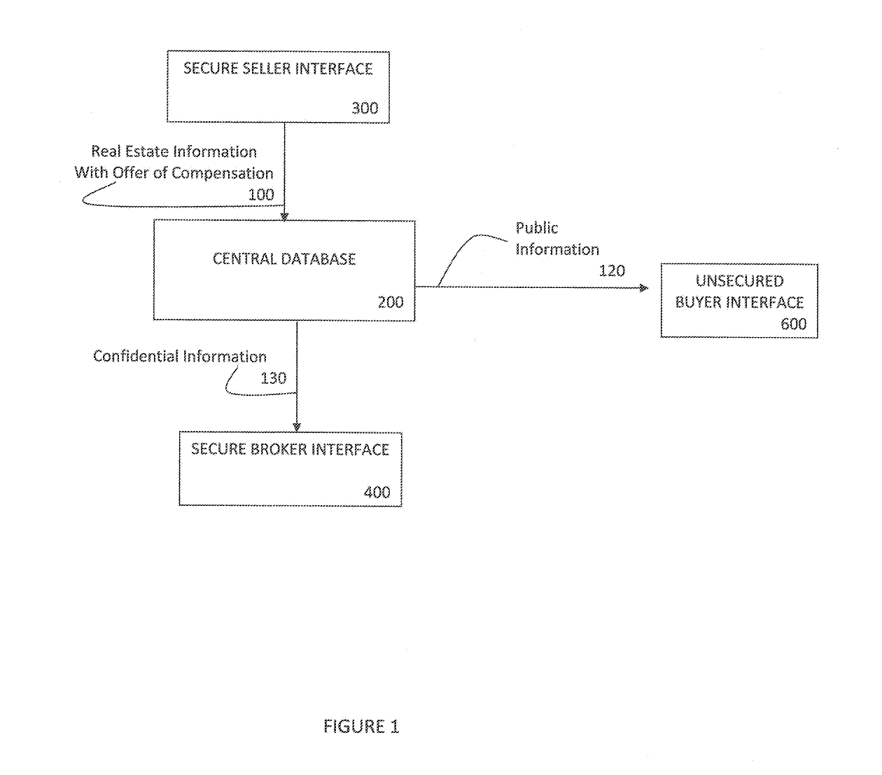

The system and method of the present invention is discussed below with reference to FIGS. 1, 2, 3 and 4.

As shown in FIG. 1, the system comprises central database 200, secure seller interface 300, secure broker interface 400, and unsecure buyer interface 600. The central database is connected to each interface via a public switched Internet Service Provider connection, such as those provided by a local or regional cable television operating company. Connection may also be provided by dedicated telephone, data lines, cellular, Personal Communication Systems, microwave, or satellite networks. Secure seller interface 300 is an input gateway for real estate information with offer of compensation 100 into the central database 200. Secure broker interface 400 and buyer interface 600 are the output gateways for communications from central database 200. Using the above commercially available components, the invention provides a system and method to post real estate information with offers of compensation 100, and make confidential information 130 available to brokers, and allow buyers direct access to non-confidential public information 120,

Central database 200 represents one or more computers operating common web application server and database server software. Central database 200 maintains information on sellers with fields such as name and contact information, and properties with fields identifying characteristics such as address/location, square footage, bedrooms, bathrooms, etc. Before information is disseminated, the seller may be required to demonstrate evidence of capability to convey ownership of real property. For example, the seller might submit a copy of tax records identifying him/her as an owner, or a copy of the last recorded deed demonstrating he/she is a legal owner of record.

Central database 200 also maintains information on brokers authorized to access confidential information with data fields such as name, company, company address, phone number, ID number, license locations, real estate license number(s), electronic mail address, etc. This information is obtained when the broker first registers as a user of the system.

FIG. 1 also depicts secure seller interface 300, secure broker interface 400, and unsecure buyer interlace 600. These components are all conventional computing devices (personal computers, laptop computers, smart phones, notebook computers, etc.) having a network interface such as a modem. Secure seller interlace 300 and secure broker interlace 400 both interface with central database 200 via password protected connections. Unsecure buyer interlace 600 interfaces with central database 200 via unprotected connections.

In one embodiment of the present invention, communications between sellers, brokers, and buyers occur via electronic networks, with central database 200 configured, as a web server. The seller logs onto central database 200, enters real estate information with offer of compensation 100, and then disconnects from the network. Public information 120 is made available to buyers. Both public information 120 and confidential information 130 containing the seller's offer of compensation for brokers is made available to brokers. Periodic maintenance is performed by central database 200 to ensure that real estate information with offers of compensation 100 is current and has not expired.

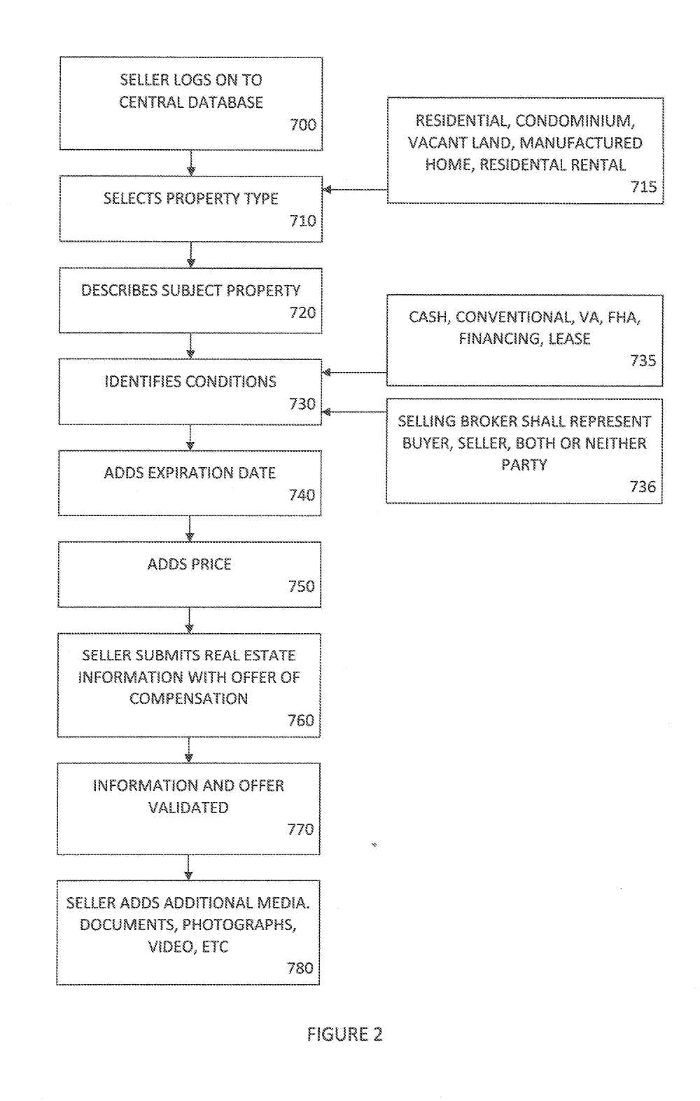

FIG. 2 further details the process by which the seller submits real estate information with offer of compensation 100 (see FIG 1). At step 700, the seller logs on to central database 200 using seller interface 300, establishing a password protected communication link (see FIG. 1). It should be emphasized that the seller is an individual, with authority to convey title to the subject real, property which may be owned by an individual, a corporation, a partnership, a government, or any other legal entity. In one embodiment, central database 200 has a page on the world wide web, allowing the seller to provide information using common web browser software. At step 710, the seller selects the type of property lie/she wants to sell by selecting from a list of possible options. As shown in box 715, options might include residential, condominium, apartment, vacant land, manufactured homes, residential rentals etc. After the property type is selected, a form is displayed on seller interface 300. This form is an. electronic offer of compensation with data inputs to be completed by the seller, with each blank representing the identity or a characteristic of the subject property,

At step 720, the seller enters a description of the subject real property. A home owner, for example, might want to sell a residence in. Houston TX. The description of the home might include the square footage of the structure, the lot square footage, the number of bedrooms, the number of bathrooms, interior features, exterior features, amenities, community, etc. There would be a place on the form identifying the compensation offered to brokers. The seller then adds conditions at step 730. As indicated in box 735, financial. conditions could specify the terms of payment the seller will accept. The seller, for example, may only accept cash terms or may accept conventional, VA or FHA financing, or for rental properties the seller may require a lease. In a preferred embodiment, the form also identifies the agency relationship and fiduciary responsibility of the broker being compensated. As shown in box 736, the seller's offer of compensation may require that the broker represent the buyer, the seller, both buyer and seller equally, or neither buyer nor seller. Conditions identified in step 730 are the terms allowing the seller to tailor seller's offer of compensation to his specific needs. Step 730 is a core factor of seller-driven real estate commerce.

At step 740, the seller adds an expiration date. At step 750, the seller enters a price. At step 760, the seller enters the real estate information with offer of compensation 100 to central database 200 by clicking on a “submit” button located on the screen in which steps 700, 710, 7.15, 720, 730, 735, 740 and 750 were completed. Central database 200 may also maintain a database of unique seller ID numbers, which may be attached to the seller's real estate information with offer of compensation 100.

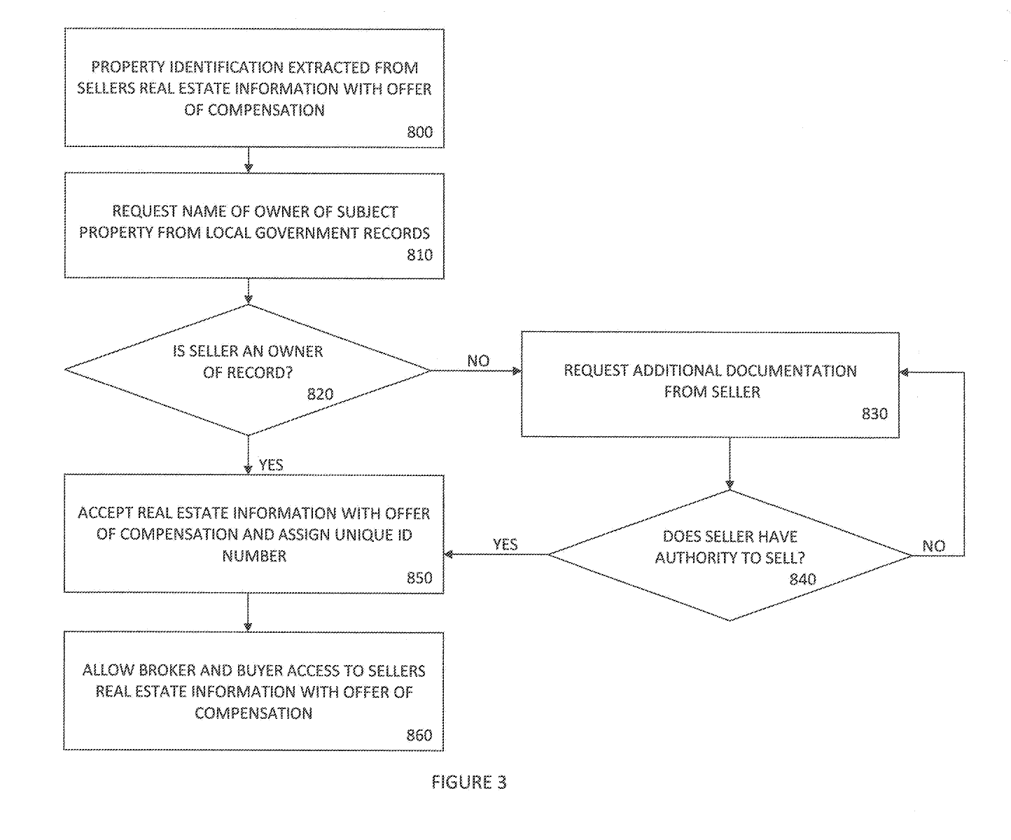

At step 770 the above elements are transmitted to central database 200 which then creates a unique ID number for the seller's real estate information with offer of compensation 100. (Note: Step 770 is further detailed in FIG. 3.) At step 780, the seller adds additional media information such as a copy of the last recorded deed, interior and exterior photographs, a video of the community, etc.

As an alternative to the world wide web-based interface, sellers may also transmit real estate information with offer of compensation 100 in person or via electronic mail, facsimile, or postal mall transmissions. These submissions of seller's real estate information with offer of compensation 100 may be transcribed by staff members into digital text at central database 200.

Referring now to FIG. 3 which illustrates how the seller's real estate information with offer of compensation 100 is received and validated to ensure sellers have authority to convey ownership before information is made available to brokers and buyers. At step 800, the price and property identification information are extracted from the seller's real estate information with offer of compensation 100. At step 810, the name of the owner of the subject property is retrieved from the local government jurisdiction where the property is located. At step 820, the name of the seller is compared with the name of the owner of record retrieved in step 810. At step 830, if the seller is not an owner of record of the subject property, additional documentation is requested from the seller which demonstrates seller's authority to convey ownership of the subject property. At step 840, once additional documentation has been received, the authority of the seller to convey ownership of the subject, property is again scrutinized. If the seller has authority to convey ownership of the subject property, the seller's real estate information with offer of compensation 100 is accepted, at step 850 and a unique ID number is assigned. If the seller does not. have proper authority, the Information is rejected and returned to the seller at step 830. At step 860, brokers and buyers arc allowed access to information In the seller's real estate information with offer of compensation 100. The process illustrated in FIG 3 may require validation by authorized staff.

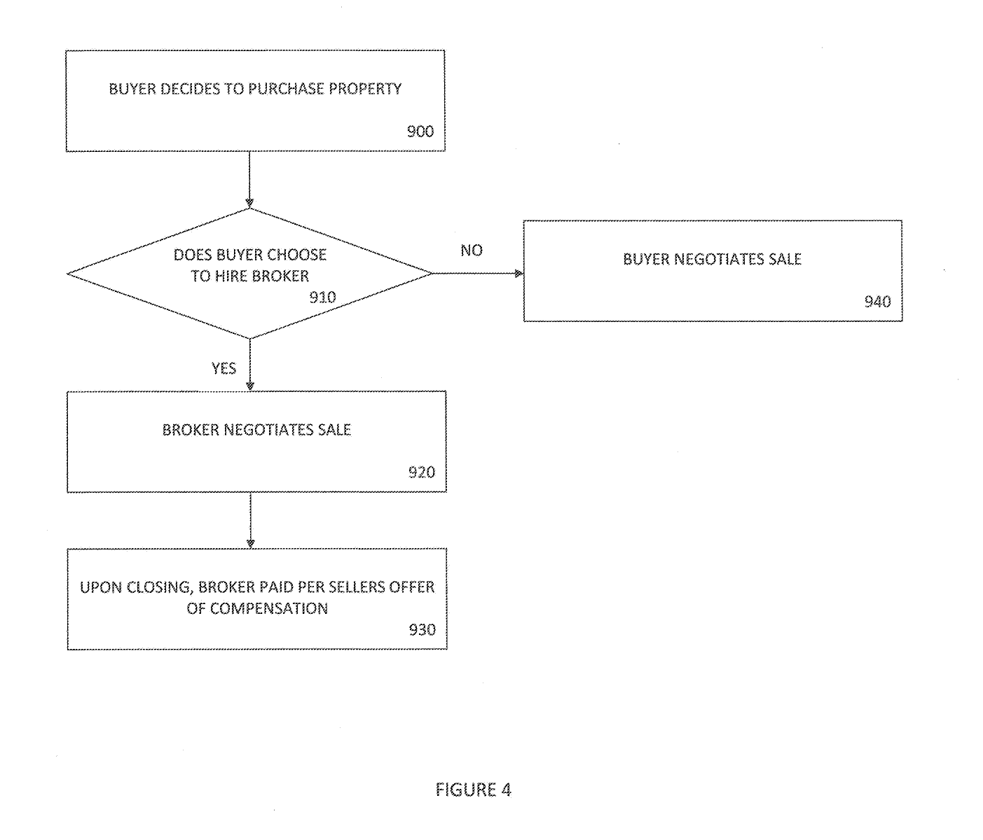

Referring now to FIG. 4 which Illustrates how a broker may be compensated in accordance with the seller's real estate information with offer of compensation 100. At step 900 a buyer has decided to purchase the subject property of a seller's real estate information with offer of compensation 100. At step 910 the buyer decides whether or not to seek the assistance of a broker in acquiring the subject property. Step 940 illustrates a buyer that decides to negotiate the purchase of the subject property without the assistance of a broker. Step 920 depicts a buyer that chooses to have a broker assist with the purchase of the subject property. The broker assists by negotiating the terms of the purchase and sale agreement. At step 930, upon closing of the sale the broker is paid in accordance with the seller's offer of compensation (see FIG. 1 step 100). Step 930 illustrates a core factor in seller-driven real estate commerce.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention Is therefore claimed in any of its forms or modifications within the legitimate and valid scope of the amended claims, appropriately interpreted in accordance with the doctrine of equivalents.

I claim:

1. A method for enhancing real estate commerce between a seller of a piece of real estate, a buyer of a parcel of real estate and a real estate professional, said method comprises the steps of:
a. selecting a parcel of real estate own by a seller to be sold;
b. generating sales information regarding said parcel of real estate to be sold;
c. transmitting said sales information to a network accessible exclusively to real estate professionals, said sales information includes an offer of compensation;
d. transmitting said sales information to a network accessible to all buyers of parcels of real estate;
e. electing by the buyers to negotiate a sales agreement by directly communicating with said seller or electing to use a real estate professional to negotiate a sales agreement with said seller; and
f. whereby when said real estate professional elected, said real estate professional is compensated according to said offer of compensation transmitted with said sales information.
